(19) United States
(12) Patent Application Publication
(10) Pub. No.: US 2009/0231362 A1
(43) Pub. Date: Sep. 17, 2009

(54) Method of Reproducing Microscope Observation, Device of Reproducing Microscope Observation, Program for Reproducing Microscope Observation, and Recording Media Thereof

(75) Inventors: Sadayuki Kaba, Gunma (JP); Kiyotada Washiya, Akita (JP)

Correspondence Address: HOGAN & HARTSON L.L.P., 1999 AVENUE OF THE STARS, SUITE 1400, LOS ANGELES, CA, 90067, US

(73) Assignee: NATIONAL UNIVERSITY CORPORATION GUNMA UNIVERSITY, Maebashi-shi, Gunma (JP)

(21) Appl. No.: 11/814,161

(22) PCT Filed: Jul. 22, 2005
(86) PCT No.: PCT/JP2005/013898

§ 371 Date: Nov. 20, 2008

(30) Foreign Application Priority Data
Jan. 18, 2005 (JP) 2005-10758

(51) Int. Cl. G09G 5/00; G06F 3/048; G06T 13/00; H04N 7/18; G06F 17/30

(52) U.S. Cl. 345/660; 715/715; 348/79; 707/100; 707/E17.044; 348/E07.085

(57) ABSTRACT

A plurality of data of still image for screening and zooming shot at maximum magnification to perform magnified observation with regard to a plurality of divided areas obtained by dividing a shoot target area in a microscopic image such that a portion of a peripheral portion of each of the dividing areas is overlapped to each other, and a plurality of data of still image for focusing shot by respectively shifting focus in each of the divided areas, are created. From data of tiled still image for screening and zooming and data of edited still images for focusing, which are obtained by applying a predetermined processing to the data of still image, an animated image for screening, an animated image for zooming, and an animated image for focusing are created, and an animated image reproducing motion of a microscopic image in actual microscope observation is displayed on a computer screen. And, when a mouse cursor is located on a specific region of the animated image, a comment balloon about the specific region is displayed.

### TECHNICAL FIELD

The present invention relates to reproduction of microscope observation performed in a histopathologic examination and cytodiagnosis on a computer, and display of a comment balloon at this time.

### BACKGROUND ART

Conventionally, when presenting a microscopic image of a histopathologic specimen and a cytodiagnosis specimen in academic conferences and workshops, a still image thereof is displayed by using a slide and a photograph. However, information of a specimen obtained by a microscope is detailed and wide-ranging, so that only limited information of the specimen is reported by the still image. And, in the cytodiagnosis, the shot still image is mainly judged by laboratory technicians and doctors, so that objective judgment thereof is naturally limited.

Consequently, the inventor of the present application has already proposed to more precisely reproduce the microscope observation performed in the histopathologic examination and cytodiagnosis on the computer by using an animated image, on the Web site (refer to Kiyotada WASHIYA, “Microscope Imaging Technology, reproducing the microscope observation” [online], Feb. 3, 2003, Japanese Society of Cytotechnologists, http://www.intercyto.com/research/MIT1/index.htm).

The animated image herein proposed is to reproduce a variety of operations in observation by the microscope on the computer. Namely, in the microscope observation, observation is conducted by performing various operations such as screening (moving observation) of the cytodiagnosis specimen, zooming (magnified observation) and focusing (stereoscopic observation) of cell to be remarked, and confirmation from low-power magnification (entire) to high-power magnification (portion) of a tissue specimen. In the above-described proposal, an animated image, which reproduces motion of the microscopic image seen when screening, zooming, and focusing in the actual microscope observation (referred to as Animated Microscopic Image) is displayed on the computer screen, and when a user inputs operations indicating screening, zooming and focusing to the computer, the animated image, which moves similarly to the motion in the actual microscopic image, is played according to the input. The input of operation is performed by operating a screening button, a zooming button, and a focusing button displayed on the computer screen by using a mouse or the like, and by dragging the images.

For example, when the operation for screening is inputted, the microscopic image displayed on the computer screen moves in a screening direction. Namely, the microscopic image actually appearing in the screening direction is sequentially and smoothly displayed. At this time, if the operation for zooming is further input, the microscopic image on the computer screen is magnified or reduced. Namely, the microscopic image actually appearing by being magnified or reduced is displayed immediately. Thereby, it becomes possible to check remarked tissue or cell by high-power magnifying the same while observing the low-power magnified image covering a wide range, and the screening and the zooming are faithfully reproduced. As a matter of course, the focusing also is reproduced in a similar manner.

Meanwhile, disclosure in the above-described Web page is limited to a display of the reproduced animated image and the operation thereof, and a specific creating method of the animated image is not specifically disclosed. And, it is considered that further effective presentation and learning may be realized if a comment balloon about a specific region of the animated image is displayed. For example, by automatically displaying the comment balloon about the cell to be remarked, such as an atypical cell, and tissue, considered to be important from an educational training viewpoint, a detailed virtual microscopic learning becomes possible.

### DISCLOSURE OF INVENTION

Accordingly, in view of the above-described circumstances, an object of the present invention is to provide a method of reproducing microscope observation, a device of reproducing microscope observation, a program for reproducing microscope observation, capable of reproducing a various operations in observation by a microscope, on a computer, and a recording media thereof.

And another object of the present invention is to provide the method of reproducing microscope observation, the device of reproducing microscope observation, the program for reproducing microscope observation, capable of displaying a comment balloon about a specific region of the above-described animated image, and the recording media thereof.

In order to solve the above-described problem, a first aspect of the present invention provides a method of reproducing microscope observation, including:

receiving input of a plurality of data of still image for screening and zooming shot at maximum magnification to perform magnified observation with regard to a plurality of divided areas obtained by dividing a shoot target area in a microscopic image such that a portion of a peripheral portion of each of the divided areas is overlapped to each other, by means of a processing unit;

receiving input of a plurality of data of still image for focusing shot by respectively shifting focus in each of the divided areas, by means of the processing unit;

allowing a storage unit to store a plurality of input data of still image for screening and zooming and a plurality of input data of still image for focusing, by means of the processing unit;

taking the plurality of data of still image for screening and zooming out of the storage unit, joining the data, cutting out a desired range to create data of tiled still image for screening and zooming and allowing the storage unit to store the data of tiled still image for screening and zooming, by means of the processing unit;

taking the plurality of data of still image for focusing out of the storage unit, editing each data of still image for focusing with same precision to create data of edited still image for focusing, and allowing the storage unit to store the data of edited still image for focusing, by means of the processing unit;

taking the data of tiled still image for screening and zooming out of the storage unit to create an animated image for screening and an animated image for zooming, and allowing the storage unit to store the animated image data, by means of the processing unit;

taking the data of edited still image for focusing out of the storage unit to create an animated image for focusing, and allowing the storage unit to store the animated image, by means of the processing unit; and

displaying an animated image reproducing motion of a microscopic image seen in screening, zooming and focusing in an actual microscope observation, on a computer screen, by means of the processing unit.

A second aspect of the invention provides the method of reproducing the microscope observation according to the above-described first aspect of the invention, wherein displaying the animated image reproducing the microscope observation on the computer screen, when a mouse cursor is located on a specific region of the animated image, a comment balloon is displayed about the specific region.

A third aspect of the invention provides a method of reproducing microscope observation, including: displaying an animated image reproducing microscope observation on a computer screen; and when a mouse cursor is located on a specific region of the animated image, displaying a comment balloon about the specific region.

And a fourth aspect of the invention provides a device of reproducing microscope observation, including:

means for inputting a plurality of data of still image for screening and zooming shot at maximum magnification to perform magnified observation with regard to a plurality of divided areas obtained by dividing a shoot target area in a microscopic image such that a portion of a peripheral portion of each of the divided areas is overlapped to each other;

means for receiving input of a plurality of data of still image for focusing shot by respectively shifting focus in each of the divided areas;

means for allowing a storage means to store a plurality of input data of still image for screening and zooming and a plurality of input data of still image for focusing;

means for taking the plurality of data of still image for screening and zooming out of the storage means and joining the data, then cutting out a desired range to create data of tiled still image for screening and zooming, and allowing the storage means to store the data of tiled still image for screening and zooming;

means for taking the plurality of data of still image for focusing out of the storage means, editing each of the data of still image for focusing with same precision to create data of edited still image for focusing, and allowing the storage means to store the data of edited still image for focusing;

means for taking the data of tiled still image for screening and zooming out of the storage means to create an animated image for screening and an animated image for zooming, and allowing the storage means to store the animated image data;

means for taking data of edited still image for focusing out of the storage means to create an animated image for focusing and allows the storage means to store the animated image data; and

means for displaying an animated image reproducing motion of a microscopic image in screening, zooming and focusing in actual microscope observation, on a computer screen.

A fifth aspect of the invention provides the device of reproducing microscope observation according to the fourth aspect of the invention, further including:

means for storing a comment balloon about the specific region of the animated image in advance; and

means for reading and displaying the comment balloon about the specific region when a mouse cursor is located on the specific region of the animated image which is displayed.

A sixth aspect of the invention provides a device of reproducing microscope observation including:

means for creating an animated image reproducing microscope observation;

means for displaying the animated image which is created;

means for storing a comment balloon about a specific region of the animated image in advance; and

means for reading and displaying the comment balloon about the specific region when a mouse cursor is located on the specific region of the animated image which is displayed.

And a seventh aspect of the invention provides a program for reproducing microscope observation, which allows a computer to operate as:

means for receiving input of a plurality of data of still image for screening and zooming shot at maximum magnification to perform magnified observation with regard to a plurality of divided areas obtained by dividing a shoot target area in a microscopic image such that a portion of a peripheral portion of each of the divided areas is overlapped to each other;

means for receiving input of a plurality of data of still image for focusing shot by respectively shifting focus in each of the divided areas;

means for allowing a storage means to store a plurality of input data of still image for screening and zooming and a plurality of input data of still image for focusing;

means for taking the plurality of data of still image for screening and zooming out of the storage means, joining the data, cutting out a desired range to create data of tiled still image for screening and zooming, and allowing the storage means to store the data of tiled still image for screening and zooming;

means for taking the plurality of data of still image for focusing from the storage means, editing each data of still image for focusing with same precision to create data of edited still image for focusing, and allowing the storage means to store the data of edited still image for focusing;

means for taking data of tiled still image for screening and zooming out of the storage means to create an animated image for screening and an animated image for zooming, and allowing the storage means to store the animated image data;

means for taking data of edited still image for focusing from the storage means to create an animated image for focusing, and allowing the storage means to store the animated image data; and

means for displaying an animated image reproducing motion of a microscopic image seen in screening, zooming, and focusing in actual microscope observation.

An eighth aspect of the invention provides the program for reproducing microscope observation according to the seventh aspect of the invention, which allows the computer to operate further as:

means for storing a comment balloon about a specific region of the animated image in advance,

means for reading and displaying the comment balloon about the specific region when a mouse cursor is located on the specific region of the animated image which is displayed.

A ninth aspect of the invention provides a program for reproducing microscope observation, which allows a computer to operate as:

means for creating an animated image reproducing microscope observation;

means for displaying the animated image which is created;

means for storing a comment balloon about a specific region of the animated image in advance; and

means for reading and displaying the comment balloon about the specific region when a mouse cursor is located on the specific region of the animated image which is displayed.

Further, a tenth aspect of the invention provides a computer-readable recording media, which stores the program for reproducing microscope observation according to any one of the seventh to ninth aspects.

According to the above-described microscope observation method and microscope observation device, it becomes possible to precisely reproduce the animated image for reproducing the microscope observation (hereinafter, referred to as “AMI”) on the computer. And while displaying, it is possible to optionally automatically display the comment balloon about the specific region, for example, cell to be remarked, such as an atypical cell, and tissue, considered to be important from an educational training viewpoint, thereby a detailed virtual microscopic learning becomes possible.

According to the above-described microscope observation program and recording media, the computer program capable of obtaining a similar effect as that of the above-described invention of the microscope observation method and the microscope observation device, and the recording media, such as a flexible disc, a CD, a DVD, which records the same, may be realized.

### BRIEF DESCRIPTION OF DRAWINGS

FIGS. 1(a) to (d) are views showing editing of a still image for screening and zooming;

FIGS. 2(a) to (d) are views showing creation of an animated image of an image for screening and zooming;

FIGS. 3(a) and (b) are views showing creation of an animated image of an image for focusing;

FIGS. 4(a) to (d) are views showing a method of creating an AMI capable of displaying a comment balloon;

FIG. 5 is a system configuration diagram showing an embodiment of the present invention, and

FIGS. 6(a) to (d) are views each showing a hardcopy of a computer screen when displaying a comment balloon.

### BEST MODE FOR CARRYING OUT THE INVENTION

Hereinafter, an embodiment of the present invention will be described.

First, the embodiment of a method of creating an AMI reproduced as an animated image for microscope observation according to the present invention is described. Meanwhile, although an example in which the image of a cytological microscopical specimen is handled is herein described, the present invention is not limited to this.

(1) Images for the AMI are shot as digital images by using a digital camera or a high-vision camera exclusively for the microscope. And, to create the AMI, software for image editing and tiling, and software for creating an animated image are used. As such software, commercially available software may be used. For example, as the software for image editing and tiling, Photoshop elements 2.0 (trademark: manufactured by Adobe Systems Incorporated) or the like may be used, and as the software for creating the animated image, HotMedia Creator that comes with Homepage Builder V9 (trademark: manufactured by IBM) or the like may be used. Hereinafter, it will be described with the herein exemplified software.

(2) Shooting of Digital Image
(i) Image for Screening and Zooming

A range to shoot is decided, and an entire objective field of view is shot at maximum magnification to perform magnified observation. Meanwhile, since the images are tiled, they are shot such that 10% or more of the ranges is overlapped to each other.
(ii) Image for Focusing

Since cells overlap to each other in cell agglomeration observed in a cytological specimen, images vary according to focus. All the images, which are in focus, are shot.

(3) Editing of Images
(i) Image for Screening and Zooming

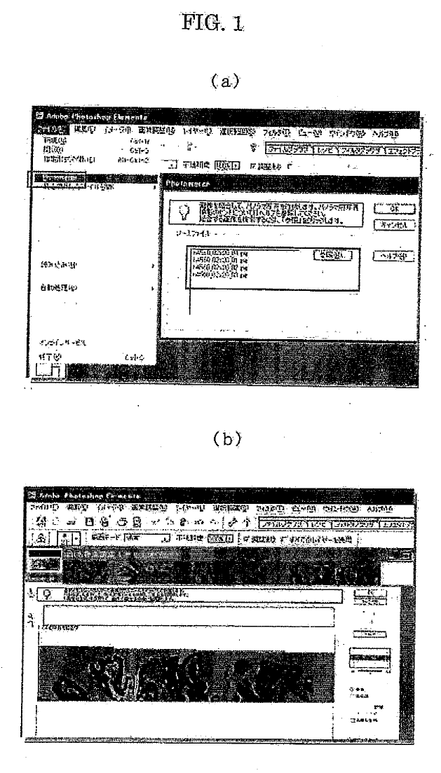

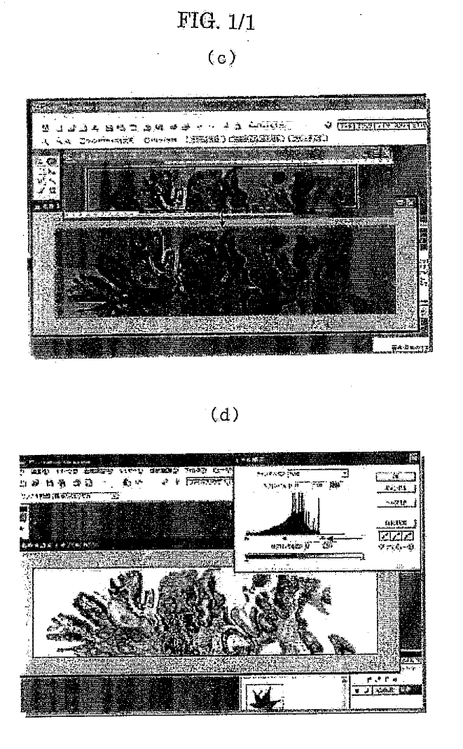

The shot images are tiled by the Photoshop elements 2.0 (trademark: manufactured by Adobe Systems Incorporated), which is a software for image editing and tiling. By selecting “Photomerge” from the file menu, and selecting all the images to be tiled by clicking a “reference button” of a source file (FIG. 1(a)), the images are automatically tiled (FIG. 1(b)). Since the tiling is performed in pixel, misalignment of the images is not recognized. After cutting out the tiled image (FIG. 1(c)) and editing the same, the image is saved with a file name (FIG. 1(d)).
(ii) Image for Focusing

The obtained images are edited with same precision. Herein, a term “edit” is intended to mean to stack a plurality of images, which are shot by shifting the focus in a certain divided area, in a focusing direction (a direction perpendicular to a surface on which the images exist). The images for focusing are not tiled. Meanwhile, concerning methods of editing the digital images and of keeping precision thereof, please refer to Kiyotada WASHIYA, “Operation of Internet Survey,” Medical Technology, 2001, 1: pp. 75-81, and Kiyotada WASHIYA, “The 43rd Cytodiagnosis Seminar (at Sendai),” Handout, pp. 67-76, 2001.

(4) Creating Animated Image

A process of creating an animated microscopic image (AMI) by using the HotMedia Creator, which is a software for creating animated image, will be described.
(i) Image for Screening and Zooming

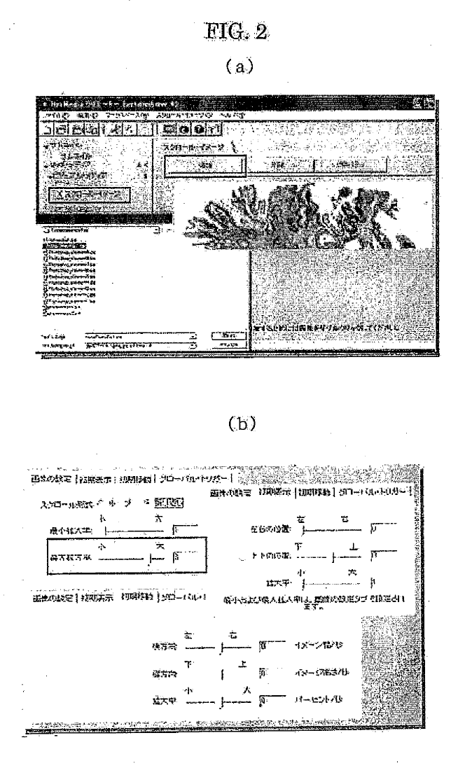

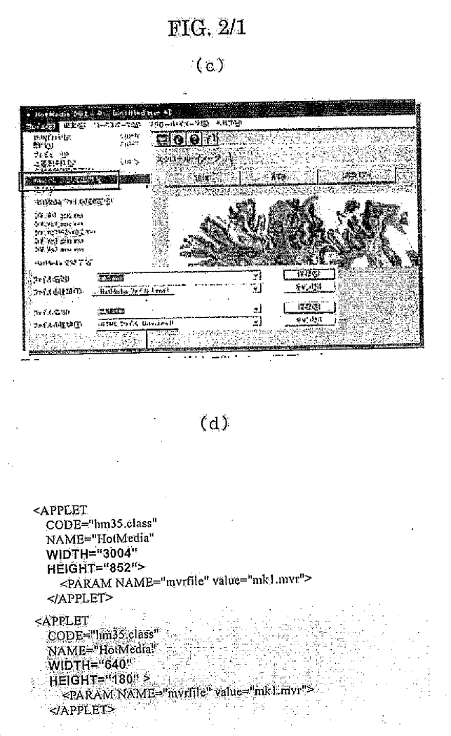

A scroll image on a HotMedia Creator screen is checked, and the tiled image is read by clicking an “add button” (FIG. 2(a)). Setting of the image (maximum magnifying power: 3, initial movement: 0, initial display: 1) is performed by clicking a “property button” (FIG. 2(b)), and the image is saved as a Web page from the file menu (FIG. 2(c)). Since two files, which are mvr file (animated image) and html file, are herein created, a html source file is opened and image size “(WIDTH, HEIGHT)” enclosed by “APPLET” is changed to a size desired to be displayed on a personal computer (FIG. 2(d)). Execution of the AMI is performed by activating the html file.
(ii) Image for Focusing

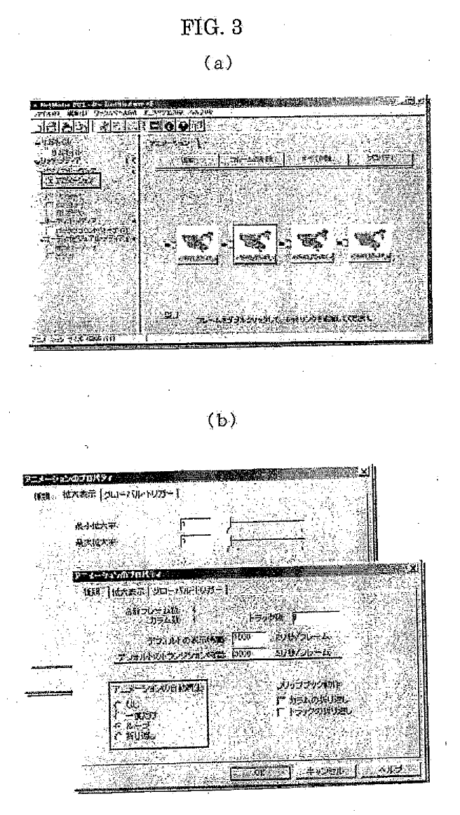

An animation of a start-up screen of the HotMedia Creator is checked, and the image shot for focusing is read by clicking the “add button” (FIG. 3(a)). Setting of the image (auto play of animation: loop/default transition time [display interval time]: 3000) is performed by clicking the “property button” (FIG. 3(b)), and the image is saved as the Web page with two names, which are mvr and html. When the html file is activated, the AMI is activated.

Next, a method of creating the AMI capable of displaying a comment balloon will be described.

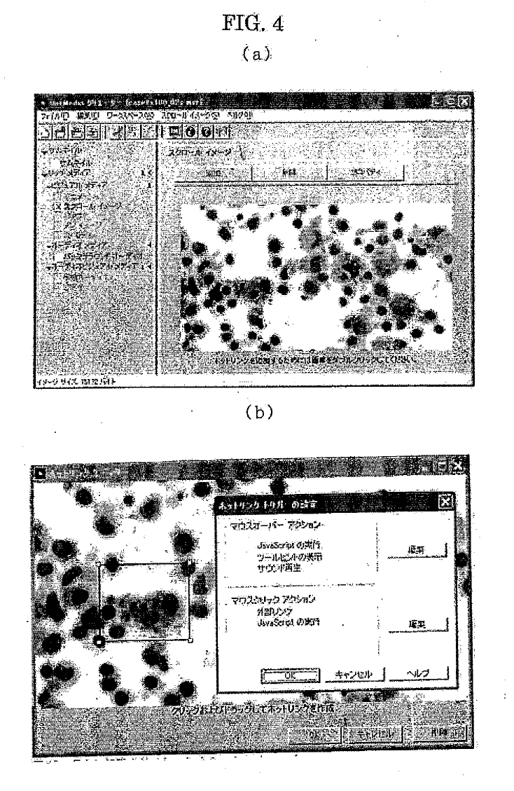

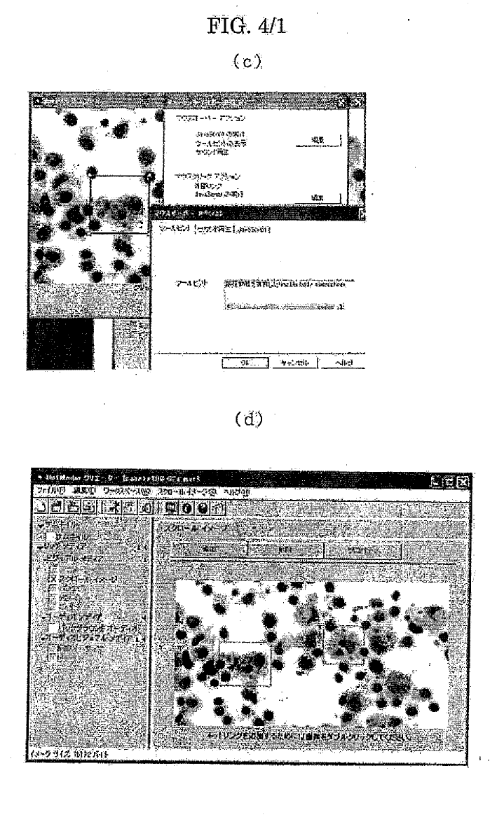

The mvr file created by the HotMedia Creator is specified (double clicked) and opened (FIG. 4(a)), and the opened image is double clicked to pop up, to create the comment balloon. Next, when enclosing a cell (region) to which the comment balloon is to be added in a square by dragging a mouse, a “hotlink trigger setting screen” is opened (FIG. 4(b)). Then, a “mouse over action edit button” is clicked to enter a description in a “tool hint field” (FIG. 4(c)). By repeating operations shown in FIGS. 4(b) and 4(c), a plurality of comment balloons may be set (FIG. 4(d)). Although the html file also has a comment balloon function, named Alt tag, this disappears after a few seconds. In this respect, the comment balloon by the above-described process does not disappear during being pointed, so that it is possible to carefully learn the same when used as a learning material.

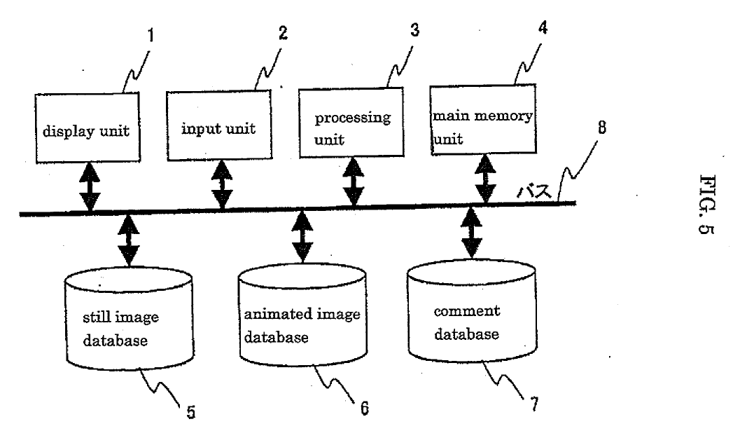

Next, an embodiment of the present invention, capable of displaying the comment balloon, will be described in detail with reference to FIG. 5. FIG. 5 is a system configuration diagram of the microscope observation device of the invention of the present application.

First, a processing unit 3 accepts a plurality of digital data of still image for screening and zooming shot at maximum magnification to perform magnified observation from an input unit 2, with regard to a plurality of divided areas obtained by dividing a shoot target area in the microscopic image such that a peripheral portion of each of the divided areas is overlapped to each other, in response to a command of a program stored in a main memory unit 4. And the processing unit 3 accepts a plurality of digital data of still image for focusing shot by respectively shifting focus in each of the divided areas. Then the processing unit 3 allows a still image database 5 to store a plurality of input data of still image for screening and zooming and a plurality of input data of still image for focusing.

Subsequently, the processing unit 3 takes the plurality of data of still image for screening and zooming out of the still image database 5, joins the data to each other, and cuts out a desired range to create data of tiled still image for screening and zooming. And the processing unit 3 allows the still image database 5 to store the data of tiled still image for screening and zooming.

Also the processing unit 3 takes a plurality of data of still image for focusing out of the still image database 5, edits each of the data of still image for focusing with same precision to create data of edited still image for focusing. And the processing unit 3 allows the still image database 5 to store the data of edited still image for focusing, which is created.

Next, the processing unit 3 takes the data of tiled still image for screening and zooming out of the still image database 5 to create an animated image for screening and an animated image for zooming, and allows an animated image database 6 to store the animated image data.

And the processing unit 3 takes the data of edited still image for focusing out of the still image database 5 to create an animated image for focusing, and allows the animated image database 6 to store the animate image data.

In this way, the AMI is created.

When displaying the AMI, the processing unit 3 first reads the AMI stored in the animated image database 6 in response to the command of the program stored in a main memory unit 4, and displays the same in a display unit 1.

Subsequently, the processing unit 3 displays a mouse cursor on the AMI, which is displayed. The mouse cursor is configured to move on the AMI in conjunction with mouse action by a user.

When the user inputs operations indicating screening, zooming and focusing to the computer, the animated image, which moves similarly to motion in an actual microscopic image, is played according to the input. The input of operation is performed by operation of a button for screening, a button for zooming, and a button for focusing, by dragging of images, or the like.

When inputting the operation for screening, the microscopic image displayed on a computer screen moves in a screening direction, and the microscopic image, which actually appears in the screening direction, is continuously smoothly displayed. Herein, by further inputting the operation for zooming, the microscopic image on the computer screen is magnified or reduced. Thereby, it becomes possible to check remarked tissue and cell by high-power magnifying the same while observing the low-power magnified image covering a wide range, and the screening and the zooming are faithfully reproduced. As a matter of course, the focusing also is reproduced in a similar manner.

The case in which a comment balloon about a specific region of the AMI is displayed will be described. In this case, when the mouse cursor is located on the specific region of the AMI, the processing unit 3 displays the comment balloon about the specific region. Concerning the comment balloon, one or more of the specific region(s) of the AMI is/are set in advance, balloon comment data is created for each specific region, and the same is stored in a comment database 7. The processing unit 3 performs tracking of motion of the mouse cursor on the AMI, and when the mouse cursor locates on the set specific region, this reads the balloon comment data of the corresponding specific region from the comment database 7 and displays the same immediately.

Thereby, only by moving the mouse cursor to remarked region while observing the AMI, the user may refer to a specific comment about the region and may learn about important regions while simulating microscope operation.

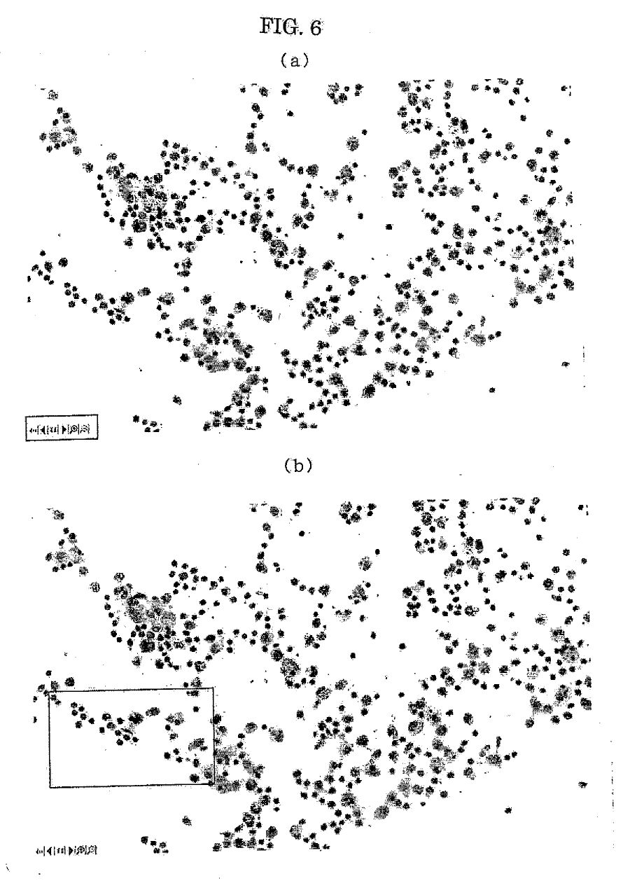

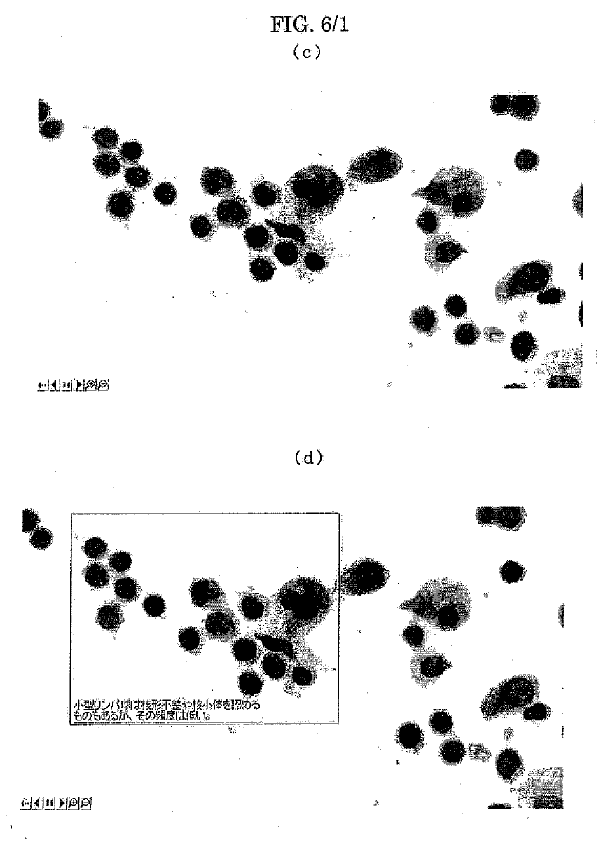

Each of FIGS. 6(a) to (d) is a specific example in which the comment balloon is displayed.

First, as shown in FIG. 6(a), the mouse cursor is displayed on the AMI of the cytological specimen displayed on the computer screen, and while the mouse cursor moves on the AMI in conjunction with the mouse operation of the user, when this passes by the region considered to be important in learning, a frame of an area including the region is displayed as shown in FIG. 6(b). Next, by clicking inside of the frame, the AMI in the frame is magnified and displayed as shown in FIG. 6(c). And further, when the mouse cursor passes by one of the region considered to be important in learning in a magnified AMI, the comment balloon about the region is displayed as shown in FIG. 6(d). At this time, the user merely moves the mouse cursor on the AMI by mouse operation, and when the mouse point is located on the specific region, the comment balloon is automatically displayed.

In this way, in this example, following operation becomes possible as a whole.

First, by inputting the operation for screening, the microscopic image displayed on the computer screen moves in the screening direction. Namely, the microscopic image appearing in the screening direction is continuously smoothly displayed.

At this time, by further inputting the operation for zooming, the microscopic image on the computer screen is magnified or reduced. Namely, the microscopic image actually appearing by being magnified or reduced is shown at once. Thereby, it becomes possible to check remarked tissue and cell by high-power magnifying the same while observing the low-power magnified image covering a wide range, and the screening and the zooming are faithfully reproduced.

And by performing the operation for focusing, for example, when spatially observing a certain cell agglomeration, the focusing is faithfully reproduced in a similar manner.

Furthermore, while the user moves the mouse cursor on the AMI, when this passes by the region considered to be important in learning, the frame of the area including the region is displayed, and the comment balloon about the region is displayed.

Therefore, as described above, the microscope observation of the target specimen is precisely reproduced on the computer, so that this is very useful not only in the presentation in academic conferences or the like, but also in microscope learning.

As a matter of course, the present invention is not limited to the above-described embodiment, and various aspects are possible in detail. For example, the present invention may be applied not only to the microscope observation but also to the endoscope observation and the naked eye observation. The animated image, which moves similarly to the motion in the actual observation, may be created to optionally display the comment balloon, while playing the animated image according to the operation input by the user.

1. A method of reproducing microscope observation, comprising:
receiving input of a plurality of data of still image for screening and zooming shot at maximum magnification to perform magnified observation with regard to a plurality of divided areas obtained by dividing a shoot target area in a microscopic image such that a portion of a peripheral portion of each of the divided areas is overlapped to each other, by means of a processing unit;
receiving input of a plurality of data of still image for focusing shot by respectively shifting focus in each of the divided areas, by means of the processing unit;
allowing a storage unit to store a plurality of input data of still image for screening and zooming and a plurality of input data of still image for focusing, by means of the processing unit;
taking the plurality of data of still image for screening and zooming out of the storage unit, joining the data, cutting out a desired range to create data of tiled still image for screening and zooming and allowing the storage unit to store the data of tiled still image for screening and zooming, by means of the processing unit;
taking the plurality of data of still image for focusing out of the storage unit, editing each data of still image for focusing with same precision to create data of edited still image for focusing, and allowing the storage unit to store the data of edited still image for focusing, by means of the processing unit;
taking the data of tiled still image for screening and zooming out of the storage unit to create an animated image for screening and an animated image for zooming, and allowing the storage unit to store the animated image data, by means of the processing unit;
taking the data of edited still image for focusing out of the storage unit to create an animated image for focusing, and allowing the storage unit to store the animated image, by means of the processing unit; and
displaying an animated image reproducing motion of a microscopic image seen in screening, zooming and focusing in an actual microscope observation, on a computer screen, by means of the processing unit.

2. The method of reproducing the microscope observation as claimed in claim 1, wherein while displaying the animated image reproducing the microscope observation on the computer screen, when a mouse cursor is located on a specific region of the animated image, a comment balloon is displayed about the specific region.

3. A method of reproducing microscope observation, comprising: displaying an animated image reproducing microscope observation on a computer screen; and when a mouse cursor is located on a specific region of the animated image, displaying a comment balloon about the specific region.

4. A device of reproducing microscope observation, comprising:
means for inputting a plurality of data of still image for screening and zooming shot at maximum magnification to perform magnified observation with regard to a plurality of divided areas obtained by dividing a shoot target area in a microscopic image such that a portion of a peripheral portion of each of the divided areas is overlapped to each other;
means for receiving input of a plurality of data of still image for focusing shot by respectively shifting focus in each of the divided areas;
means for allowing a storage means to store a plurality of input data of still image for screening and zooming and a plurality of input data of still image for focusing;
means for taking the plurality of data of still image for screening and zooming out of the storage means, joining the data, cutting out a desired range to create data of tiled still image for screening and zooming, and allowing the storage means to store the data of tiled still image for screening and zooming;
means for taking the plurality of data of still image for focusing out of the storage means, editing each of the data of still image for focusing with same precision to create data of edited still image for focusing, and allowing the storage means to store the data of edited still image for focusing;
means for taking the data of tiled still image for screening and zooming out of the storage means to create an animated image for screening and an animated image for zooming, and allowing the storage means to store the animated image data;
means for taking data of edited still image for focusing out of the storage means to create an animated image for focusing and allowing the storage means to store the animated image data; and
means for displaying an animated image reproducing motion of a microscopic image in screening, zooming and focusing in actual microscope observation, on a computer screen.

5. The device of reproducing microscope observation as claimed in claim 4, further comprising: means for storing a comment balloon about the specific region of the animated image in advance; and means for reading and displaying the comment balloon about the specific region when a mouse cursor is located on the specific region of the animated image which is displayed.

6. A device of reproducing microscope observation comprising:
means for creating an animated image reproducing microscope observation;
means for displaying the animated image which is created;
means for storing a comment balloon about a specific region of the animated image in advance; and
means for reading and displaying the comment balloon about the specific region when a mouse cursor is located on the specific region of the animated image which is displayed.

7. A program for reproducing microscope observation, which allows a computer to operate as:
means for receiving input of a plurality of data of still image for screening and zooming shot at maximum magnification to perform magnified observation with regard to a plurality of divided areas obtained by dividing a shoot target area in a microscopic image such that a portion of a peripheral portion of each of the divided areas is overlapped to each other;
means for receiving input of a plurality of data of still image for focusing shot by respectively shifting focus in each of the divided areas;
means for allowing a storage means to store a plurality of input data of still image for screening and zooming and a plurality of input data of still image for focusing;
means for taking the plurality of data of still image for screening and zooming out of the storage means, joining the data, cutting out a desired range to create data of tiled still image for screening and zooming, and allowing the storage means to store the data of tiled still image for screening and zooming;
means for taking the plurality of data of still image for focusing from the storage means, editing each data of still image for focusing with same precision to create data of edited still image for focusing, and allowing the storage means to store the data of edited still image for focusing;
means for taking data of tiled still image for screening and zooming out of the storage means to create an animated image for screening and an animated image for zooming, and allowing the storage means to store the animated image data;
means for taking data of edited still image for focusing from the storage means to create an animated image for focusing, and allowing the storage means to store the animated image data; and
means for displaying an animated image reproducing motion of an microscopic image seen in screening, zooming, and focusing in actual microscope observation.

8. The program for reproducing microscope observation as claimed in claim 5, which allows the computer to operate further as:
means for storing a comment balloon about a specific region of the animated image in advance,
means for reading and displaying the comment balloon about the specific region when a mouse cursor is located on the specific region of the animated image which is displayed.

9. A program for reproducing microscope observation, which allows a computer to operate as:
means for creating an animated image reproducing microscope observation;
means for displaying the animated image which is created;
means for storing a comment balloon about a specific region of the animated image in advance; and
means for reading and displaying the comment balloon about the specific region when a mouse cursor is located on the specific region of the animated image which is displayed.

10. A computer-readable recording media, which stores the program for reproducing microscope observation as claimed in any one of claims 7 to 9.
